(19) United States
(12) Patent Application Publication
(10) Pub. No.: US 2006/0120086 A1
(43) Pub. Date: Jun. 8, 2006

(54) Super searchlight with power station

(76) Inventor: Se Kit Yuen, Hong Kong (CN)

Correspondence Address: Dr. Arthur King Ma, 1030 Coronado Drive, Arcadia, CA, 91007, US

(21) Appl. No.: 11/006,039

(22) Filed: Dec. 7, 2004

(51) Int. Cl. F21V 7/00

(52) U.S. Cl. 362/346; 362/276; 362/390

(57) ABSTRACT

This invention involves a searchlight with an electric energy container. This light has a handle bar, at end potion of which is a moveable sustainable super light. Said handle bar makes relative movements between position one and position two. At position one, said handle bar aligns with said searchlight body at parallel level to provide users with a handle for comfortable operation. At position two, said handle bar aligns with said searchlight body at perpendicular position to provide another handle for comfortable operation. A moveable sustainable super light at the bottom of the handle bar can provide continuous lighting for as long as 400 hours, an intensity of light powered by single source reaches up to 10,000,000 candle power, and the flood lighting range up to 50,000 meters and can rotate around revolving string at the bottom of the handle bar within a 180° arc to any desired position to provide optimal illuminating angle. Said electric energy container contains powerful charging battery energy, and provides a power outlet providing a mean of adapting power from any power outlet for continuous lighting. It increases the sense of safe, expands scope of usage and range of lighting. Said searchlight and electric energy container can perform separately or in combination to provide users with multiple carriage alternatives.

### BACKGROUND OF SAID PRESENT INVENTION

1. Field of Invention

The present invention relates a halogen searchlight and more particularly relates to a halogen searchlight with an interchangeable and portable container for battery.

2. Description of Related Arts

Military, law enforcement, fire and rescue personnel, security personnel, hunters and recreational boaters among others for nighttime surveillance in any application commonly use handheld halogen searchlights, where a high intensity spotlight is required. Nowadays, such application is highly demeaned in all anti-terrorists actions that take place at nighttime. Conditions of use are highly varied, but generally require the light to deliver a desired field of view at long distances, be reliable, durable and field maintainable in order for it to be practically used in the designed applications. Typically the light is hand carried and must be completely operable using simple and easily access manual controls, which do not require the use of two hands. In prior art xenon short-arc searchlights or illumination systems, whether handheld, portable or fixed mounted, the luminance distribution of the arc has been positioned facing in the direction of the beam (cathode to the rear), to provide a uniform beam pattern when the arc is at the focal point of the parabolic reflector. When the arc is moved slightly beyond (or slightly rearward of) the reflector's focal point, the combination of a placing all available light in the high magnification section of the reflector and collecting it in a slightly convergent manner produces roughly twice the operating range as a conventional anode-forward device.

Also, all prior arts of lanterns are focusing mainly of power sources or power supply to power up lanterns. Seldom of prior arts are aiming to improve lighting angles as most lanterns are used with handheld or placed on a table/floor or even placed with a hat. However, it is very obviously that lantern with an ability to rotate with certain degree of angles s so needed.

U.S. Pat. No. 6,685,337 provides a lanterns which combine both a flashlight with a candle together to ensure said lantern can still light up when power source is done or batteries are all used up. However, the lighting range, lighting angles and the lighting power of a candle are minimal. Such lantern light up by a candle will not be the most useful tool in an event of a big area.

U.S. Pat. No. 6,629,767 discloses a lantern with a batteries compartment with shock absorber lining to protect batteries contained therein from damage due to excessive shock applied to said batteries. Again, this lantern is only aiming a power supply to said lantern but lighting range and lighting angle are being ignored.

U.S. Pat. No. 6,702,452 provides a lantern with a tripod supporting mean. The mounting is a tripod mount so that the portable searchlight may be fixed in the field to a tripod with the second device. The mounting on the handle is a thumbscrew mount to permit mounting of an optical detection device onto the searchlight and rigidly fixed to the housing. However, this lantern provide without no ability to move any angle to obtain a better light range.

### SUMMARY OF SAID PRESENT INVENTION

The main object of the present invention is to provide halogen having a supporting means and such supporting means can provide an ability to rotate an angle more than 90 degree so as to provide a platform for user to place said halogen searchlight on a flat surface.

Another object of the present invention is to provide a halogen searchlight with power station having a supporting means and such supporting mean can provide an ability to rotate and/or to move any angles within 180° circular arc.

Another object of the present invention is to provide a halogen searchlight with power station having an ability to adopt difference power source supplies.

Another object of the present invention is to provide a halogen searchlight with power station having a supporting means and such supporting mean can provide an adjustable mean with a tight or loose positions so as to controlling such supporting mean in a locked position or in a rotating position to reach the best lighting range and lighting angles.

Accordingly, to achieve the above objects, a halogen searchlight with power station comprises:

a rectangular housing, inside of it contains a mean of lighting source;

a plurality of reflector is fixed around said mean of light source; and

a transparent front flat board;

a sealed packing collar is connecting a inner portion of said transparent front flat board and said reflector which resides inside of an annular nut, said annular nut providing a fixed position and a disassembled position on front portion of said housing. Surface of said annular nut, which is located in front of said housing, set an annular shockproof nut. It is made of rubber or other soft material to prevent said halogen searchlight with power station from shocks or quakes when excessive external force applied to it.

Said handle bar can make relative movements between position one and position two. At position one; said handle bar aligns with the light body at parallel level to provide users with a handle for comfortable operation. At position two, the said handle bar aligns with the light body at perpendicular position to provide users with a handle for comfortable operation. The aforesaid high-tech sustainable super light can rotate around the revolving string at the bottom of the handle bar with a 180° arc to any position, thus to provide the optimal lighting angle for the long-life super light.

This invention is a portable powerful energy container composed of a container equipped with a powerful charging battery, civil fast charging power circuit board, battery energy indicator, power outlet, and a storage box at the bottom for users to place some emergency tools and drugs. The powerful energy container is an energy-saving and environmentally friendly innovative invention that is featured by its fast chargeability with civil power or mobile power and its outlet adaptability to various types of mobile electric devices for powerful power supply. The powerful energy container provides powerful source for the mobile user in the event of battery failure. The joint of mobile smoke lighter is connected to the outlet of the portable powerful energy container, so that the electric energy in the container could be used to initiate the mobile engine. The portable powerful electric energy container is portable with convenient shoulder buckles. In lighting, the spotlight can be held with hands. The powerful energy container provides people with an emergency source of independent and powerful electric energy device under varied environment, climate or time. It is also used as an emergent and independent powerful energy device in navy, land force, air force, public security, firefighting, emergency treatment, disciplinary force, architectural and civil vessels.

### BRIEF DESCRIPTION OF SAID DRAWINGS

FIG. 1 is a side vide of said present invention.

FIG. 2 is a side view with handle rotated thereof.

FIG. 3 is a side view with handle and light rotated thereof.

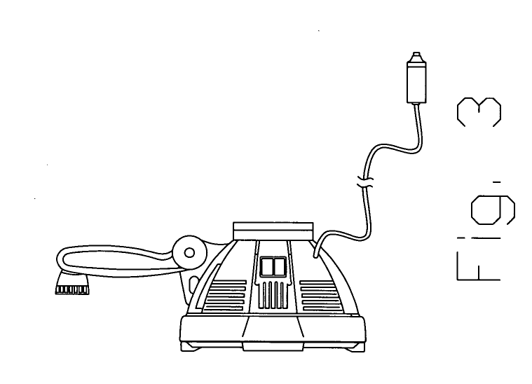

FIG. 4 is a side sectional view thereof.

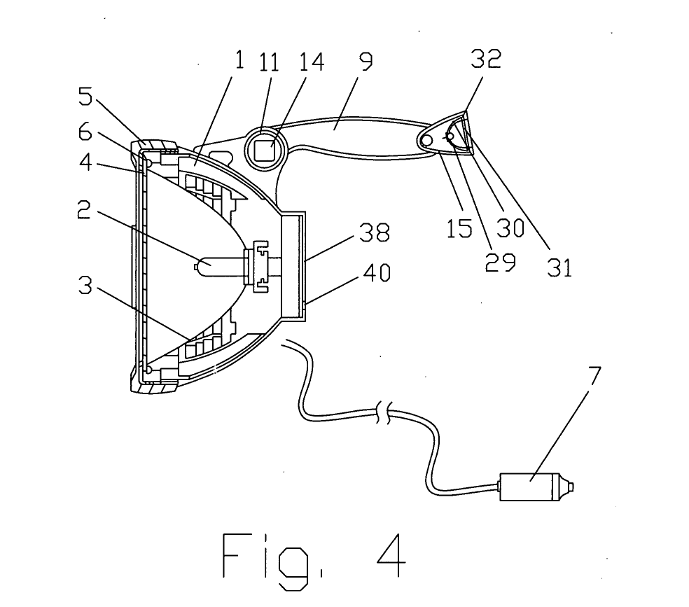

FIG. 5 is a plan view thereof.

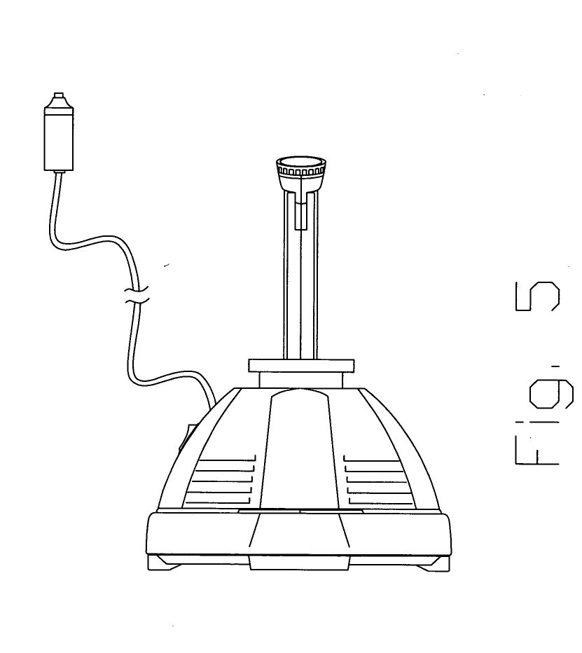

FIG. 6 is an underneath view thereof.

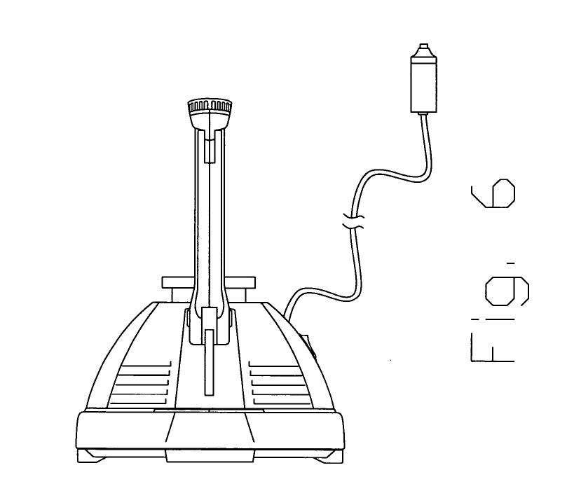

FIG. 7 is a front view thereof.

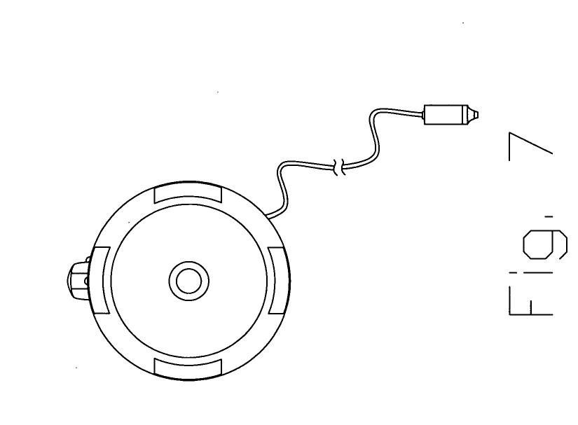

FIG. 8 is a rear view thereof.

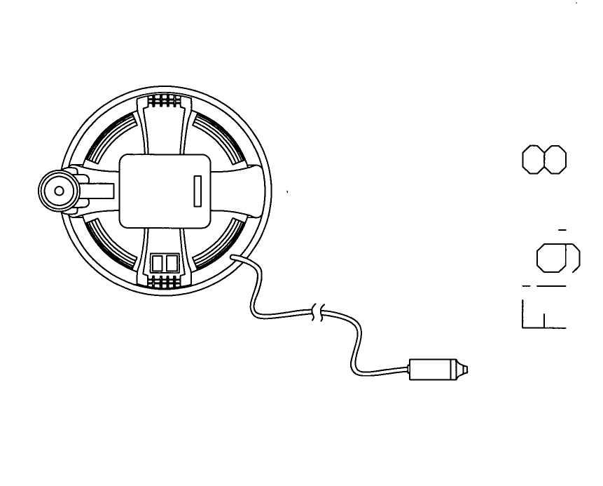

FIG. 9 is another side view thereof.

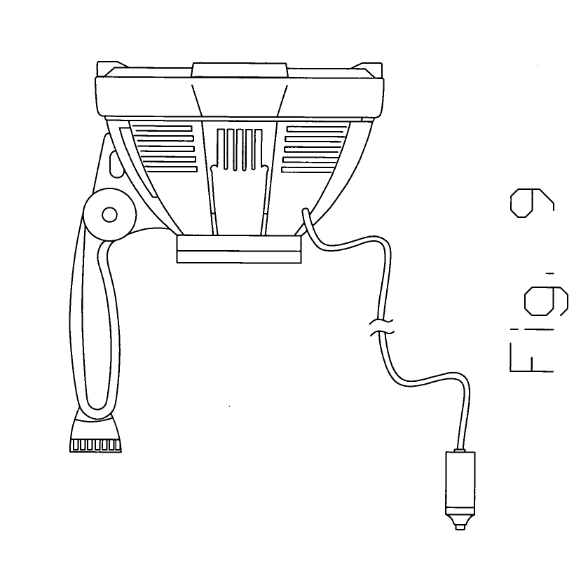

FIG. 10 is a handle's assembly view thereof.

FIG. 11 is a front view of battery pack thereof.

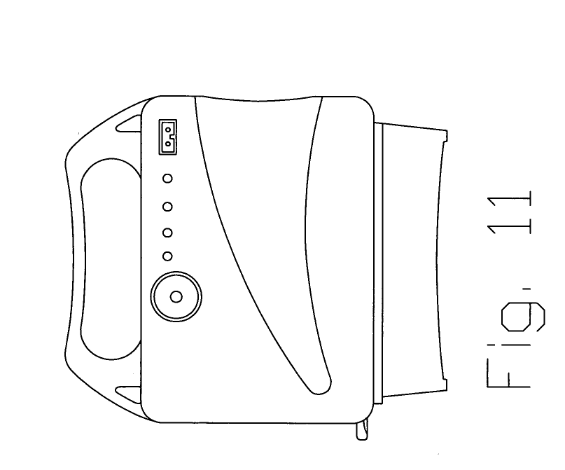

FIG. 12 is a front sectional view of battery pack thereof.

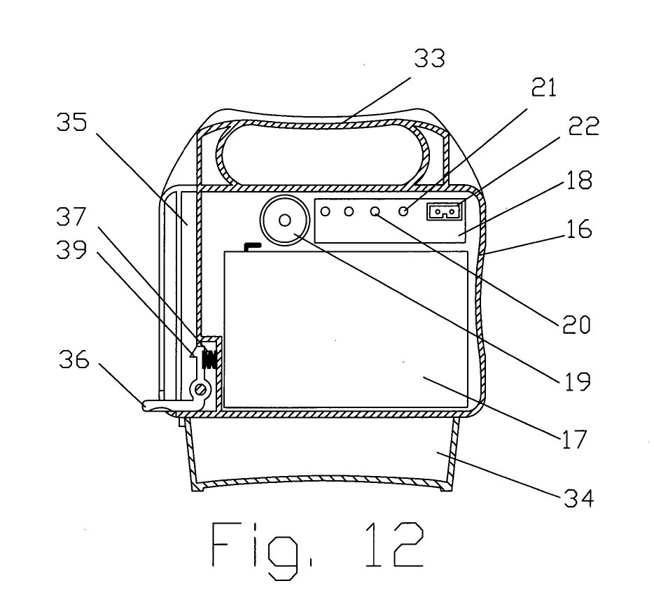

FIG. 13 is a plan view of battery pack thereof.

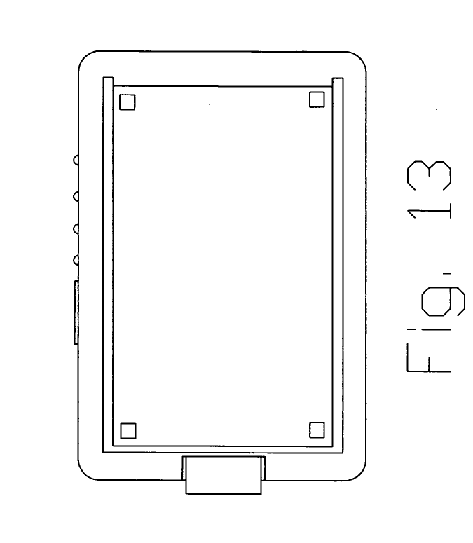

FIG. 14 is an underneath view of battery pack thereof.

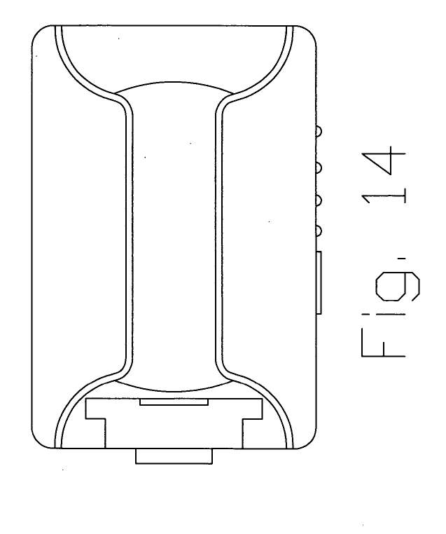

FIG. 15 is a rear view of battery pack thereof.

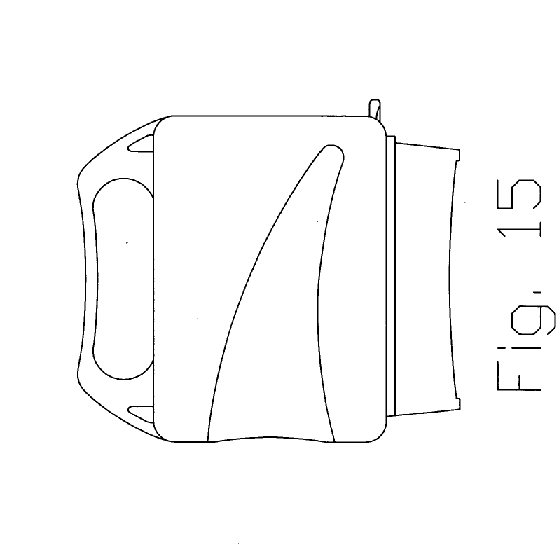

FIG. 16 is a side view of battery pack thereof.

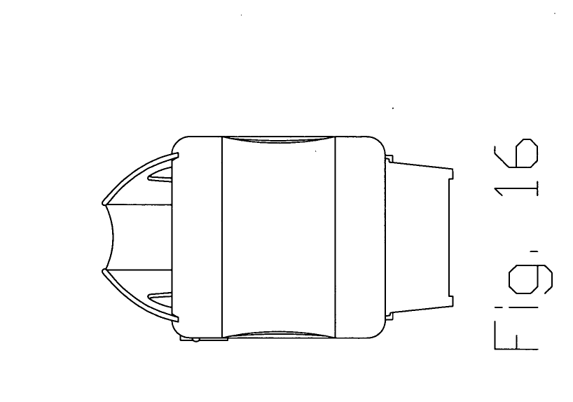

FIG. 17 is another side view of battery pack thereof.

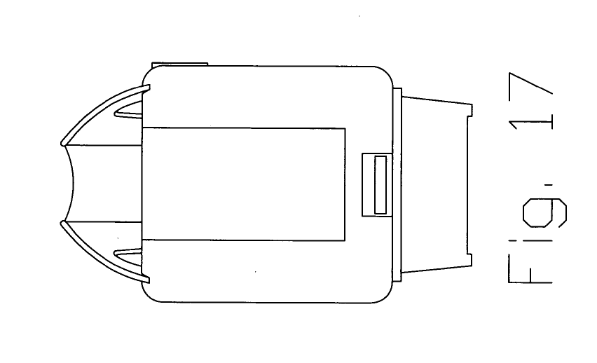

FIG. 18 is a side view of searchlight with battery pack thereof.

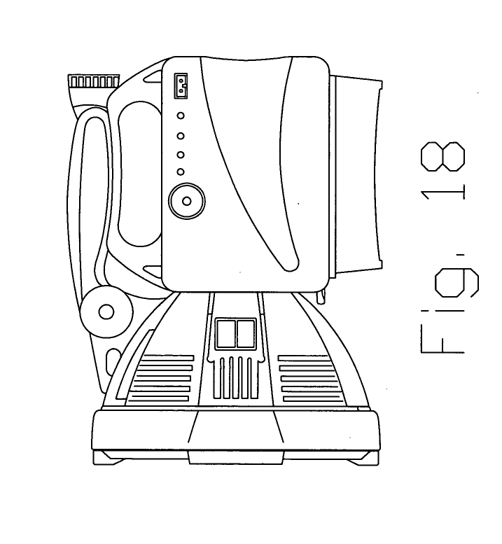

FIG. 19 is a side sectional view of searchlight with battery pack thereof.

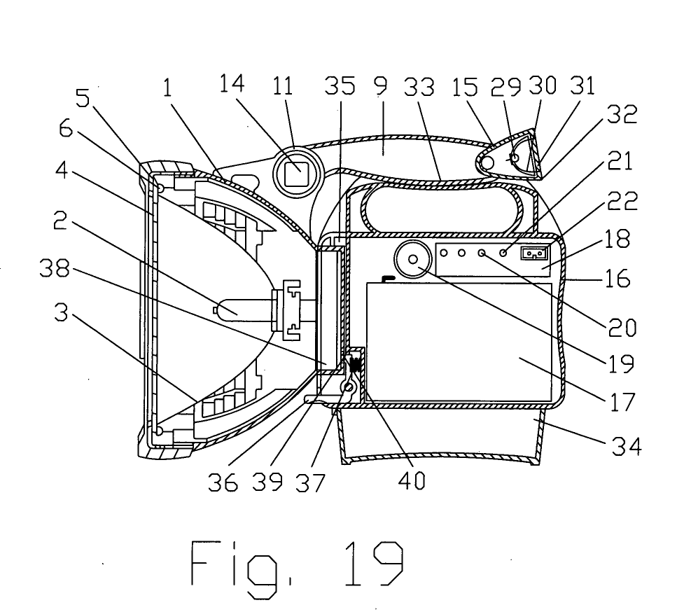

FIG. 20 is a side view of searchlight attached to battery pack thereof.

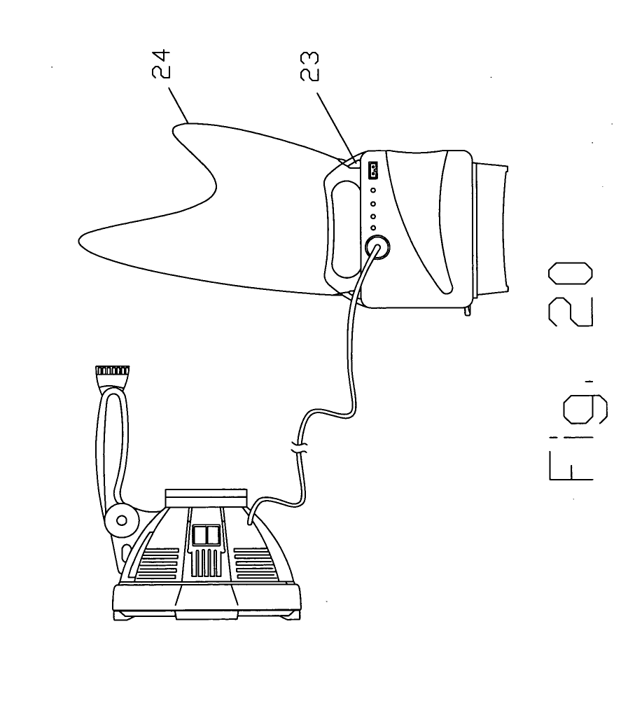

### DETAILED DESCRIPTION OF SAID PREFERRED EMBODIMENT

This present invention has a semi-circle structure body (1), an inside power halogen source (2), a usually parabola-shaped reflector (3) and a front panel made of glass or other transparent material. A sealing washer (6) seals up an inner surface of a front panel (4) and at end face of said reflector (3) inside a front annular nut (5), which secures to a front light in a flexible manner.

As illustrated in figures, said power halogen source (2) consists of a bulb, which is powered by a power joint (7) extended from said light body (1). Said power is connected to a switch knob (8) in said body (1) through power cord (7) to supply to said bulb. It is obvious that said source (2) has a battery as power.

A handle bar (9) is connected to said body (1) in a moveable manner. Said handle bar (9) is a rectangular structure, and has a circular fixed director (10) that connected to an external flange (11) of said body (1). Said external flange (11) of said body installs an inner rectangular-structured switch (12), within which there is a pivot lock (13). Said external flange (11) is fixed to said body (1).

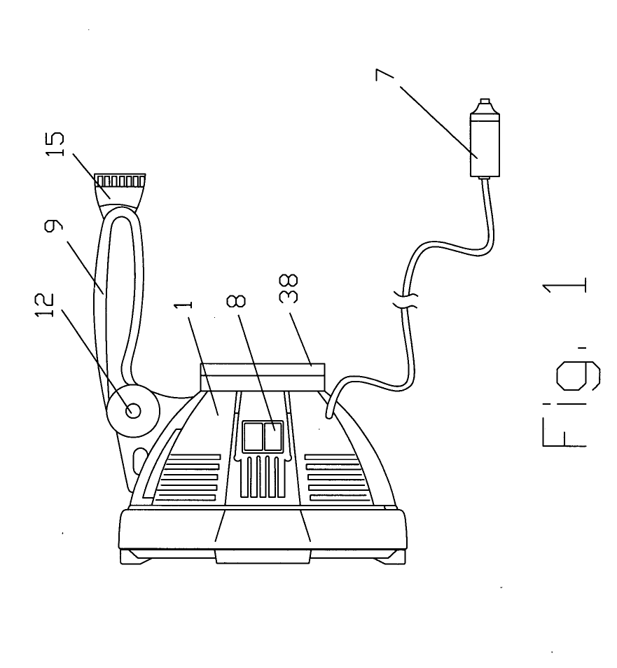

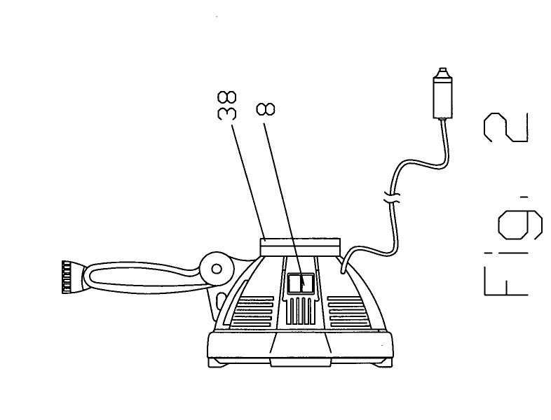

According to this invention, said handle bar (9) makes relative movements between position one, where said handle bar is regularly located as indicated in FIG. 1 and position two, where said handle bar moves around said body as indicated in FIG. 2. Referring to figures, said pivot lock (13) of said switch (12) is inserted into said square notch (14) in said center of said external flange (11), so that said circular fixed director (10) at one end of said handle bar (9) can not rotate freely, and said handle bar (9) can be fixed at position one. Affected by foreign pressure, said pivot lock (13) of said switch (12) moves backward to separate from said square notch (14) in said center of said external flange (11), so that said circular fixed director (10) at one end of said handle bar (9) could rotate freely, and said handle bar (9) can move or change to position two from said former position one. Meanwhile, as said foreign pressure disappears, said slingshot (41) within said switch (12) pushes said switch (12) back, and pushes said pivot lock (13) of said switch (12) back into said square notch (14) in said center of said external flange (11) of said body (1), so that said circular fixed director (10) at one end of said handle bar (9) can not rotate freely, and said handle bar can be fixed at position two.

Said external flange (11) of said body connects to said circular fixed director (10) at one end of said handle bar (9) to enable said handle bar (9) to make free 90-degree rotation.

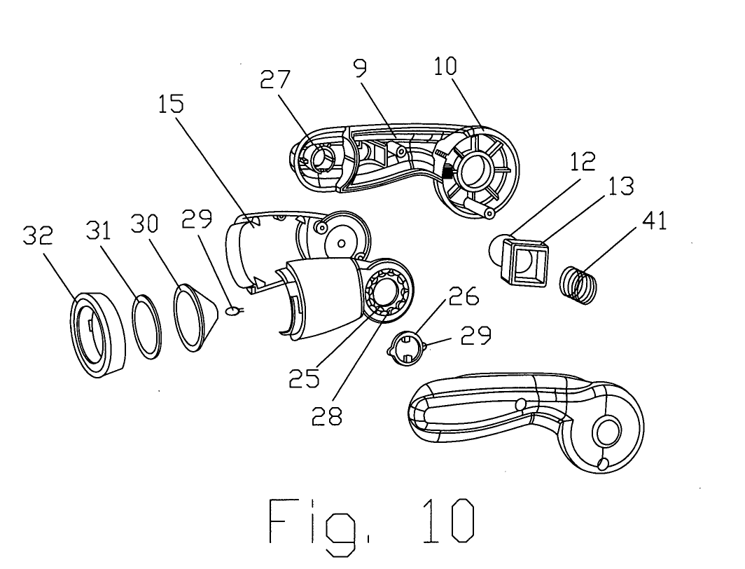

Said long-life super light (15) is connected to said bottom of said handle bar (9) in a movable manner. As indicated in FIG. 10, said movable coupling joint (25) is fixed to one end of said durable super-light (15). It also includes a flexible circular fixed director (26), which is secured within said joint axle (27) of said handle bar. Said joint axle (27) of said handle bar (9) and said circular fixed director (26) can be inserted in said gear teeth (28) of said movable coupling joint (25). Said external sphere of said fixed director (26) extends out at least one contacting gear (29) to mesh into said many gear teeth (28) in order to secure said rotary position of said sustainable super-light (15) in relate with said handle bar (9). Said gear teeth (28) are evenly placed on said external sphere of said circular fixed director (26). Said movable coupling joint (25) is connected to said durable super-light (15) and said coupling joint (27) of said handle bar (9), so as to rotate and adjust said folding angle between said long-life super light (15) and said handle bar (9), and thus provide adjustable angles of lighting.

Said aforesaid durable super-light (15) is usually structured in rectangular and equipped with a source (29), a usually parabola-shaped reflector (30) and a front panel (31) made of glass or other transparent material. It adopts sealing annular nut (32) to seal up said front panel (31) and said end surface of said reflector (30). Said annular nut (32) is secured to said front end of said durable super light (15) in a dismantling manner.

This invention of powerful photo-electronic super searchlight and electric energy container usually consists of a rectangular-shaped energy container (16), within which there is charging battery (17) and circuit board (18). On said external surface of said front container (16), there are at least one power outlet (19), said left of which installed three battery energy indicators (20) of high, medium and low that indicate respectively high, medium or low levels of internal energy in said powerful electric energy container. There is a charging indicator (21) on said left side of said energy indicators (20) that shines when said charging battery (17) is charging, and twinkles when said charging battery (17) completes charging to remind said user that said powerful electric energy container has been filled with energy for further usage.

Said front external surface of said container (16) has an external power outlet (22) that provides civil or mobile power input. Said power is then converted to appropriate energy through said charging circuit board (18) to provide fast charge for said charging battery (17).

There is a handle bar (33) on said top of said container (16). There are two buckles (23) on said external surface of lower left and right ends of said handle bar (33), from where said shoulder buckles (24) runs through. There is a movable storage at said bottom of said container (16) that provides said user with a place to deposit certain emergency tools and drugs.

User of powerful electric energy container can use shoulder buckles (24) to carry said container, or plug said power cord (7) of said hand-held spotlight into said power outlet (19) of said powerful energy container (16) to draw energy.

There is a notch (35) in said front of said container (16), under which there is a latch device (36) right next to a spring (37). Said notch (35) in said container works in conjunction with said flange (38) at said back of said body (1). Said flange (38) on said body (1) may slide into said bottom of said notch (35) from said entrance above said front container (16), so that said buckle (39) of said latch device (36) at said bottom of said notch (35) can fasten said rectangular notch (40) in said lower central flange (38) of said body (1), said body can integrate with said container (16), and said handle bar (9) on said body (1) and said handle bar (33) on said container can combine into one hand-held handle bar. When said user presses down latch device (36), said buckle (39) of said latch device (36) moves backward to separate from said rectangular notch (40) in said lower central flange (38) of said body, so that said body (1) is separated from said container (16).

Said powerful electric energy container is an energy-saving and environmentally friendly innovative invention featured by its fast chargeability by civil or mobile power with said portable powerful energy container and said outlet adaptability of said powerful energy container to power cord of varied types of mobile electric appliances. In said event of mobile battery failure, said powerful source provided by said energy container can provide mobile users with an outlet to connect to said mobile smoke igniter for power to drive said engine of said vehicle. Said powerful energy container has a handle bar (33) and a shoulder buckles for said convenience of carriage. Said user can hold said hand-held spotlight with hands. Said powerful energy container can provide people with emergency source of independent and powerful electric energy device under varied environment, climate or time. It is also used as emergent independent powerful energy device in navy, land force, air force, public security, firefighting, emergency treatment, disciplinary force, architectural and civil vessels.

What is claimed is:

1. A super halogen searchlight with power station comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said halogen searchlight from shocks or quakes when excessive external force applied to it; and
having a supporting means and such supporting mean can provide an adjustable mean with a tight or loose positions so as to controlling such supporting mean in a locked position or in a rotating position to reach the best lighting range and lighting angles; and
having a supporting mean can move relatively and interactively between position one and position two allowing tightly affixed at any position to provide an adjustable lighting angle, said supporting mean provide a support on plane surface for to provide a distance lighting mean with any angle within 90°, and
said supporting mean can also provide rotating positions through said adjustable hinge to any position within 180° circular arc. They provide support for said housing in a horizontal position to get the best lighting angle,
a portable container for carrying a battery, and
having a handle attached to said housing providing mean of carrying.

2. A halogen searchlight with power station comprises:
a rectangular housing, inside of it contains a mean of lighting source;
a plurality of reflector is fixed around said mean of light source; and
a plurality of transparent front flat board; and
a plurality of seal packing collar is connecting an inner portion of said transparent front flat board and said reflector which resides inside of a plurality of annular nut. Said plurality of annular nut providing a fixed position and a disassembled position on front portion of said housing. Surface of said annular nut, which is located in front of said housing, set of plurality of annular shockproof nut. It is made of rubber or other soft material to prevent said halogen searchlight with power station from shocks or quakes when excessive external force applied to it; and
having a supporting means and such supporting mean can provide an adjustable mean with a tight or loose positions so as to controlling such supporting mean in a locked position or in a rotating position to reach the best lighting range and lighting angles; and
having a long stand which can move relatively and interactively between position one and position two allowing tightly affixed at any position to provide an adjustable lighting angle, said supporting mean provide a support on plane surface for to provide a distance lighting mean with any angle within 90°, and
said long stand can also provide rotating positions through said adjustable hinge to any position within 180° circular arc, and
having a short stand which can move relatively and interactively between position one and position two allowing tightly affixed at any position to provide an adjustable lighting angle, said supporting mean provide a support on plane surface for to provide a distance lighting mean with any angle within 90°, and
said short stand can also provide rotating positions through said adjustable hinge to any position within 180° circular arc,
They provide support for said housing in a horizontal position to get the best lighting angle, and
having a handle attached to said housing providing mean of carrying.

3. A halogen searchlight with power station as recited in claim 1, wherein, said halogen searchlight is further comprises:
at least one light bulb,
at least one arc shaped reflector,
at least one set of main switch,
at least one power receptacle for external electricity,
at least one transformer, and
at least one set of circuitry and power supply.

4. A halogen searchlight with power station as recited in claim 1, wherein long stand and short stand can provide an adjustable mean with a tight or loose positions so as to controlling such supporting mean in a locked position or in a rotating position to reach the best lighting range and lighting angles through said attached hinge to any position within 180° circular ark. Said stands can move relatively and interactively between position one and position two allowing tightly affixed at any position to provide an adjustable lighting angle, said supporting mean provide a support on plane surface for to provide a distance lighting mean with any angle within 90°, Said stands provide supports for said housing.

5. A halogen searchlight with power station as recited in claim 1, wherein said halogen searchlight is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

6. A halogen searchlight with power station as recited in claim 1, wherein said halogen searchlight comprises a lighting source, has an energy saving halogen light bulb, which is located on a light base. Electricity is provided by a power source within said housing. Electricity current goes through power cord to the insides of electrical circuitry of said housing and transformer, while connects power receptacle, on/off switch, and links up with energy saving florescent bulb.

7. A halogen searchlight with power station as recited in claim 1, wherein said halogen searchlight can draw electricity either from AC power outlet provided from public utility or from the chargeable battery directly.

8. A halogen searchlight with power station as recited in claim 1, wherein said halogen searchlight further comprises:
a handle in a rectangular shape is longitudinally attached to said housing. A front and rear of the handle are equipped with stripes so as to provide a mean of carrying.

9. A halogen searchlight with power station as recited in claim 1, wherein said halogen searchlight further comprises:
a battery cover is located at rear portion of said housing. Metal screws tightly locked a battery cover to the rear bump of said housing. A seal packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.

10. A halogen searchlight with power station as recited in claim 2, wherein said stands can provide an adjustable mean with a tight or loose positions so as to controlling such supporting mean in a locked position or in a rotating position to reach the best lighting range and lighting angles through said attached hinge to any position within 180° circular ark. Said supporting mean can move relatively and interactively between position one and position two allowing tightly affixed at any position to provide an adjustable lighting angle, said supporting mean provide a support on plane surface for to provide a distance lighting mean with any angle within 90°, Said stands provide supports for said housing.

11. A rechargeable halogen search light as recited in claim 2, wherein said rechargeable halogen search light is a light, further comprising: a light housing to which said arc lamp is stationary mounted; a reflector housing to which said reflector is mounted;
a reflector positioner comprising a threaded coupling between said light housing and said reflector housing enabling longitudinal displacement of said reflector relative to said light housing by said user manipulation;
and a fluted heat sink mounted on said light housing, wherein said housing conductively dissipates lamp heat from said anode.

12. A halogen searchlight with power station as recited in claim 2, wherein said halogen searchlight comprises a lighting source, has an energy saving halogen light bulb, which is located on a light base. Electricity is provided by a power source within said housing. Electricity current goes through power cord to the insides of electrical circuitry of said housing and transformer, while connects power receptacle, on/off switch, and links up with energy saving halogen bulb.

13. A halogen searchlight with power station as recited in claim 2, wherein halogen searchlight t can draw electricity either from AC power outlet provided from public utility or from the chargeable battery directly.

14. A halogen searchlight with power station as recited in claim 1, wherein said halogen searchlight further comprises:
a handle in a rectangular shape is longitudinally attached to said housing. A front and rear of the handle are equipped with stripes so as to provide a mean of carrying.

15. A halogen searchlight with power station as recited in claim 1, wherein said halogen search light further comprises:
a battery cover is located at rear portion of said housing. Metal screws tightly locked a battery cover to the rear bump of said housing. A seal-packing collar fastens the light fixture's rear inside with a front end of said battery cover. Said battery cover provides disassembling position or a fixed position at rear portion of said housing. Batteries can be changed when said battery cover and said housing are separated. Surface of said battery cover contains a rubber or soft material made sealing nut. There is a lid on said sealing nut that can seal the entrance of said external receptacle, thus prevent water and is more durable.
